(19) United States
(12) Patent Application Publication
(10) Pub. No.: US 2015/0207576 A1
(43) Pub. Date: Jul. 23, 2015

(54) Method and Apparatus for Testing Frequency Division Duplexing Transceiver

(71) Applicants: Tao Huang, Beijing (CN); Xiang Zeng, Beijing (CN); Yanhui Zhao, Beijing (CN); Liushuan Zhou, Beijing (CN); Jinlai He, Beijing (CN)

(72) Inventors: Tao Huang, Beijing (CN); Xiang Zeng, Beijing (CN); Yanhui Zhao, Beijing (CN); Liushuan Zhou, Beijing (CN); Jinlai He, Beijing (CN)

(73) Assignee: Telefonaktiebolaget L M Ericsson (publ), STOCKHOLM (SE)

(21) Appl. No.: 14/424,504

(22) PCT Filed: Sep. 3, 2012
(86) PCT No.: PCT/CN2012/001228

§ 371 Date: Feb. 27, 2015

(51) Int. Cl. H04B 17/14; H04W 24/00; H04L 5/14

(52) U.S. Cl. CPC H04B 17/14; H04L 5/1461; H04W 24/00

(57) ABSTRACT

The embodiments disclose a radio frequency loop test method and apparatus for testing frequency division duplexing transceiver in a radio communication system. The apparatus comprises a first directional coupling means and a mixer. The first directional coupling means is coupled with a duplex filter to receive, at a first port, a test signal from a transmitter via the duplex filter; the mixer is coupled with first directional coupling means on both sides to receive the test signal from a second port of the first directional coupling means, convert the frequency of the test signal from the transmitter to a frequency that is receivable by a receiver, and to output the converted test signal to the first directional coupling means, and the first directional coupling means is coupled to receive, at a third port, the converted test signal from the mixer and output, at the first port, the converted test signal to the receiver via the duplex filter.

### TECHNICAL FIELD

The presented technology generally relates to wireless communication, particularly to a radio frequency (RF) loop test method and apparatus for testing frequency division duplexing (FDD) transceiver in a radio communication system, and a communication node comprising the apparatus.

### BACKGROUND

Radio frequency (RF) loop test is a method commonly used in radio systems, especially for frequency division duplexing (FDD) radio transceiver, where the transmitter (TX) and receiver (RX) are connected to a common antenna via a duplex filter as illustrated in FIG. 1. The transmitter and receiver operate at different carrier frequencies.

FIG. 3 shows the principle of the RF loop test viewed at the frequency level. The figure depicts the transmission band and the reception band in a particular system. The band is divided into channels (not shown). When the transmitter generates the test signal on a channel using the transmitter frequency, the transmitter frequency is converted into the receiver frequency by the mixer assembled on the test loop. Thus the test signal travels within the transceiver.

A simplified RF loop test implementation is shown in FIG. 2. During the RF loop test, a known test signal is sent out by transmitter 201 on the transmission frequency, then the test signal is relayed to the mixer 202, converted (by the mixer 202) into the signal with reception frequency, and finally injected into the receiver 204. The converted test signal is checked and analyzed by the receiver 204, the test indicator such as signal level and bit error rate (BER) therefore can be obtained. Similar method and variations have been described in patents, such as U.S. Pat. No. 5,337,316 Wesis et al and U.S. Pat. No. 5,521,904 Eriksson et al.

A major problem with the existing solutions is that they can only test and monitor part of the transceiver, that is, the test loop fails in including the duplex filter and the connections between the duplex filter and the transmitter and receiver. The present RF loop test circuit always has two ports, one for TX coupling and one for RX coupling, it's impossible to cover duplex filter part where TX and RX share one port.

U.S. Pat. No. 7,062,235 provides a test method that permits not only to test the TX and RX, but also the cable connecting the TX and RX to the duplex filter and the duplex filter itself. But there are some limitations, for example the duplex filter attenuation at the out band test frequency should be consistent and manageable, TX and RX operational bandwidth shall be wide enough to cover the out band test frequency. These limitations heavily depend on the duplex frequency as illustrated in FIG. 3. For different frequency bands, the duplex frequency is different. For example, the duplex frequency for 3GPP band 12 is 30 MHz while B4 is 400 MHz. Thus, when TX band and RX band are too far away from each other, it is unlikely to find a useable overlapping frequency point between RX and TX frequency band. Furthermore, in the method, the frequency used to execute the loop test is the out band frequency instead of the in band frequency used for the normal signal transmission and reception by the transceiver, but the out band frequency may not accurately reflect the state of the transceiver at the time when it executes the normal transmission and reception, thus the accuracy and effectiveness of the test method is inevitably impacted.

### SUMMARY

Therefore, it is an object to solve at least one of the above-mentioned problems.

According to an aspect of the embodiments, there is provided a radio frequency (RF) loop test apparatus for testing Frequency Division Duplexing (FDD) transceiver in a radio communication system. The apparatus comprises a first directional coupling means and a mixer, the first directional coupling means is operably coupled with a duplex filter of the transceiver to receive, at a first port of the first directional coupling means, a test signal from a transmitter via the duplex filter; the mixer is operably coupled with the first directional coupling means on both sides to receive the test signal from a second port of the first directional coupling means, convert the frequency of the test signal from the transmitter to a frequency that is receivable by a receiver, and to output the converted test signal to the first directional coupling means; and the first directional coupling means is operably coupled to receive, at a third port of the first directional coupling means, the converted test signal from the mixer and output, at the first port of the first directional coupling means, the converted test signal to the receiver via the duplex filter.

According to an aspect of the embodiments, there is provided a communication node comprising a transmitter, a receiver, a duplex filter and a common antenna in a radio communication system, the duplex filter couples the input of the receiver and the output of the transmitter to the common antenna, and the communication node further comprises an RF loop test apparatus as described above.

According to another aspect of the embodiments, there is provided a method for testing FDD transceiver in a radio communication system, the method establishes a test loop between a transmitter and a receiver, where the test loop includes a duplex filter, a directional coupling means, a synthesizer and a mixer, the duplex filter and the directional coupling means provide two-way transmission path for the test loop; then transmits a test signal from the transmitter to the test loop via the duplex filter; converts the frequency of the test signal to a frequency that is receivable by the receiver; receives the converted test signal from the test loop via the duplex filter; and subsequently acquires a loop test result based on the received test signal.

In the embodiments, the loop test can provide a fully coverage of the function and performance of the radio transceiver. Meanwhile, the loop test is not constrained by the duplex frequency, in particular, the overlapping frequency point between RX and TX frequency band. Furthermore, since the test signal can be transmitted on the in band frequency used for the normal signal transmission and reception by the transceiver, the loop test accuracy and effectiveness is guaranteed.

### BRIEF DESCRIPTION OF THE DRAWINGS

The technology will now be described, by way of example, based on embodiments with reference to the accompanying drawings, wherein:

FIG. 1 schematically illustrates the structure of a FDD transceiver;

FIG. 2 schematically illustrates the existing RF loop test circuit used for testing the transceiver;

FIG. 3 illustrates the transmission and reception frequency bands;

FIG. 4 schematically illustrates the structure of a directional coupler;

FIG. 5 schematically illustrates a RF loop test apparatus in accordance with an embodiment;

FIG. 6 schematically illustrates a RF loop test apparatus in accordance with an embodiment;

FIG. 7 schematically illustrates a communication node including the RF loop test apparatus in accordance with an embodiment;

FIG. 8 schematically illustrates a communication node including the RF loop test apparatus in accordance with an embodiment; and

FIG. 9 illustrates a flowchart of a method for testing FDD transceiver in a radio communication system in accordance with an embodiment.

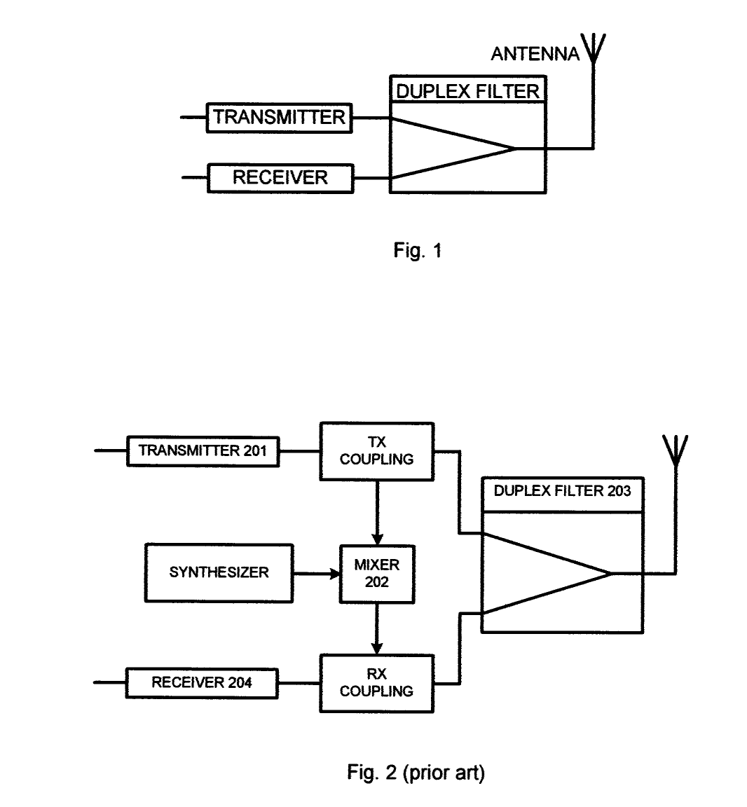

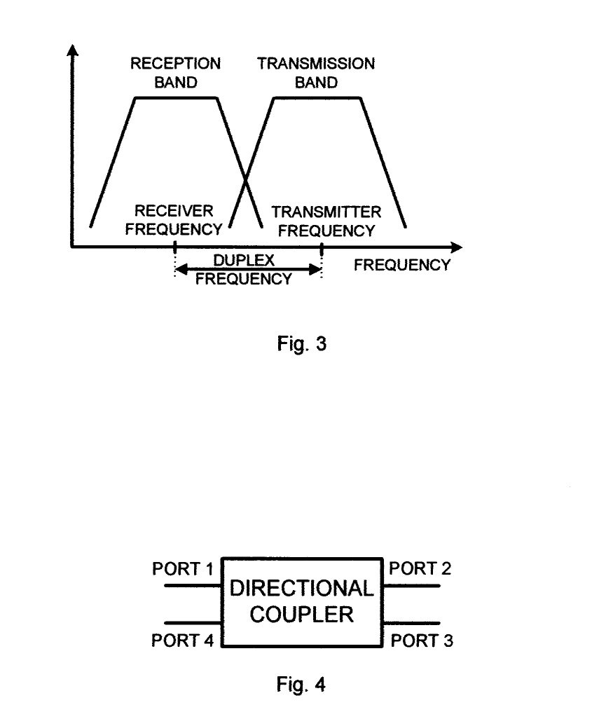

### DETAILED DESCRIPTION

Embodiments herein will be described more fully hereinafter with reference to the accompanying drawings, in which embodiments are shown. This embodiments herein may, however, be embodied in many different forms and should not be construed as limited to the embodiments set forth herein. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

The present technology is described below with reference to block diagrams and/or flowchart illustrations of methods, apparatus (systems) and/or computer program products according to the present embodiments. It is understood that blocks of the block diagrams and/or flowchart illustrations, and combinations of blocks in the block diagrams and/or flowchart illustrations, may be implemented by computer program instructions. These computer program instructions may be provided to a processor, controller or controlling circuit of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Although specific terms in some specifications are used here, such as base station, it should be understand that the embodiments are not limited to those specific terms but may be applied to all similar entities, such as macro base station, femto base stations, NodeB and eNodeB

Embodiments herein will be described below with reference to the drawings.

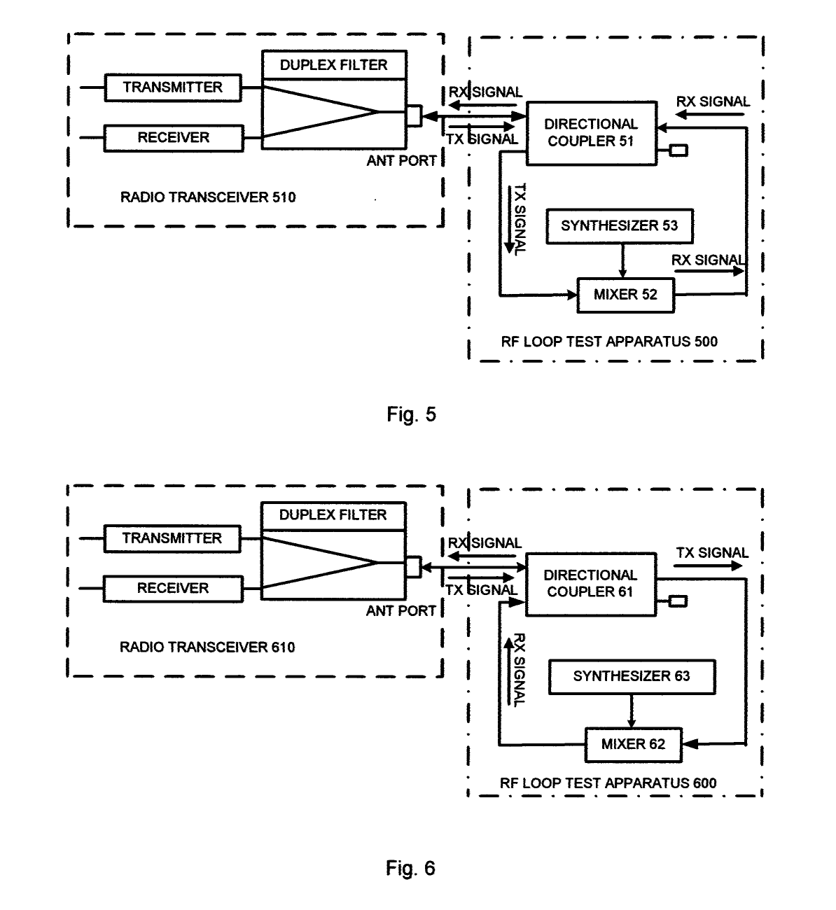

FIG. 5 schematically illustrates a RF loop test apparatus in accordance with an embodiment.

As shown in FIG. 5, the radio transceiver 510 is delineated with dash line on the left hand, and the RF loop test apparatus 500 used for testing the radio transceiver is delineated with dash line on the right hand. The RF loop test apparatus is detachably coupled with the transceiver through the antenna port of the duplex filter in the transceiver. The apparatus 500 comprises a directional coupler 51, a mixer 52 and a synthesizer 53.

Here, the directional coupler 51 couples a defined amount of the electromagnetic power in a transmission line to a port enabling the signal to be used in another circuit. An essential feature of the directional coupler is that they only couple power flowing in one direction. Power entering the output port is not coupled to the input port. The directional coupler 51 is described in detail with reference to the FIG. 4, the directional coupler has four ports, which are respectively regarded as the “input” port (e.g. port 1), the “through” port (e.g. port 2) where most of the input signal exits, the “coupled” port (e.g. port 4) where a fixed faction of the input signal appears and the “isolated” port (e.g. port 3) which is usually terminated. As known, the directional coupler is a passive reciprocal network, in other words, for example, if the signal is reversed so that it enters into the directional coupler via the port 2 (which is previously regarded as the “through” port functions as the “input” port now), then most of the signal will exit from the port 1 (which is previously regarded as the “input” port functions as the “through” port now), accordingly the port 3 functions as the “coupled” port while the port 4 functions as the “isolated” port in the example. The different working modes of the directional coupler are listed in the table below.

| | PORT 1 | PORT 2 | PORT 3 | PORT 4 |
|---|---|---|---|---|
| WORKING | INPUT | THROUGH | ISOLATED | COUPLED |
| MODE 1 | | | | |
| WORKING | THROUGH | INPUT | COUPLED | ISOLATED |
| MODE 2 | | | | |
| WORKING | COUPLED | ISOLATED | THROUGH | INPUT |
| MODE 3 | | | | |
| WORKING | ISOLATED | COUPLED | INPUT | THROUGH |
| MODE 4 | | | | |

The mixer 52 is a nonlinear electrical circuit that creates new frequencies from two signals applied to it. In its most common application, two signals at frequencies f1 and f2 are applied to the mixer, and it produces new signals at the sum f1+f2 and difference f1−f2 of the original frequencies. Generally, the mixer is used to shift signals from one frequency range to another. Preferably, the mixer 52 is a broadband mixer. The synthesizer 53 acts as a source providing the mixer with the local oscillator signal that aids to create the signal with the new frequency.

Now returning to FIG. 5, the directional coupler 51 is coupled to the duplex filter in the transceiver by the port 1 of the directional coupler 51, and coupled to the mixer 52 with the port 4 in connection with the input of the mixer 52, and the port 2 in connection with the output of the mixer 52. As such, the test loop is formed for testing the transceiver 510 by the RF loop test apparatus 500.

In the loop test, the transmitter in the transceiver sends out a known test signal, which is lead through the duplex filter to the directional coupler 51. The direction coupler 51 receives the test signal at the port 1 (the directional coupler 51 works in mode 1 for the test signal), and the directional coupler 51 couples the test signal and feeds it to the mixer 52 through the port 4, where the frequency of test signal is converted from the transmission frequency to the reception frequency that is receivable by the receiver. Then the frequency-converted test signal is passed back to the directional coupler 51 via the port 2 (the directional coupler 51 works in mode 2 for frequency-converted test signal), and the frequency-converted test signal is directed to the duplex filter through the port 1 of the directional coupler 51, subsequently it proceeds to the receiver. In this way, the RF loop test signal goes through the transmitter, duplex filter and receiver in the transceiver.

FIG. 6 schematically illustrates a RF loop test apparatus in accordance with another embodiment. In the embodiment, the configuration of the RF loop test apparatus 600 substantially is similar to the apparatus 500 in FIG. 5, except that the port 2 of the directional coupler 61 is coupled to the input of the mixer 62, while the port 4 of the directional coupler 61 is coupled to the output of the mixer 62. For purpose of concision, the elements in the apparatus 600 will be described further.

During the loop test, the transmitter in the transceiver sends out a known test signal, which is lead through the duplex filter to the directional coupler 61. The direction coupler 61 receives the test signal at the port 1 (the directional coupler 61 works in mode 1 for the test signal), and the directional coupler 61 couples the test signal and feeds it to the mixer 62 through the port 2, where the frequency of test signal is converted from the transmission frequency to the reception frequency that is receivable by the receiver. Then the frequency-converted test signal is passed back to the directional coupler 61 via the port 4 (the directional coupler 61 works in mode 3 for frequency-converted test signal), and the frequency-converted test signal is directed to the duplex filter through the port 1 of the directional coupler 61, subsequently it proceeds to the receiver. In this way, the RF loop test signal also goes through the transmitter, duplex filter and receiver in the transceiver.

Due to a small number of elements used, the RF loop test apparatus can be designed to have smaller size and run on battery power. It's also easy to configure the apparatus just by setting the synthesizer frequency. This makes it suitable to replace expensive portable RF instrument for radio base station (RBS) site maintenance and radio unit trouble shooting. It can also be used for radio transceiver lab verification, function test and so on.

Alternatively, in the RF loop test apparatus, the directional coupler can be substituted with a power divider, such as a 3 DB power divider. As well known, power dividers and directional couplers are in all essentials the same class of device. Directional coupler tends to be used for 4-port devices that are loosely coupled, that is, a fraction of the input power appears at the coupled port. Power divider is used for devices with tight coupling (commonly, a power divider will provide half the input power at each of its output ports—a 3 dB divider) and is usually considered a 3-port device with isolated port terminated with a matching load. Hence, both the directional coupler and the power divider are applicable to the embodiment.

In the above embodiments, the RF loop test apparatus is implemented as a separate apparatus. Note that the RF loop test apparatus also can be implemented as a component within a communication node, such as transceiver. Alternatively, the RF loop test apparatus can be implemented as a circuit integrated within the duplex filter of the transceiver.

In the embodiment, the RF loop test is generally carried out when there is no traffic and the frequency channel is free for a certain time period. It should be appreciated that other suitable criteria to initiate the RF loop test can also be applied to the embodiment. For example, the RF loop test can be initiated upon request.

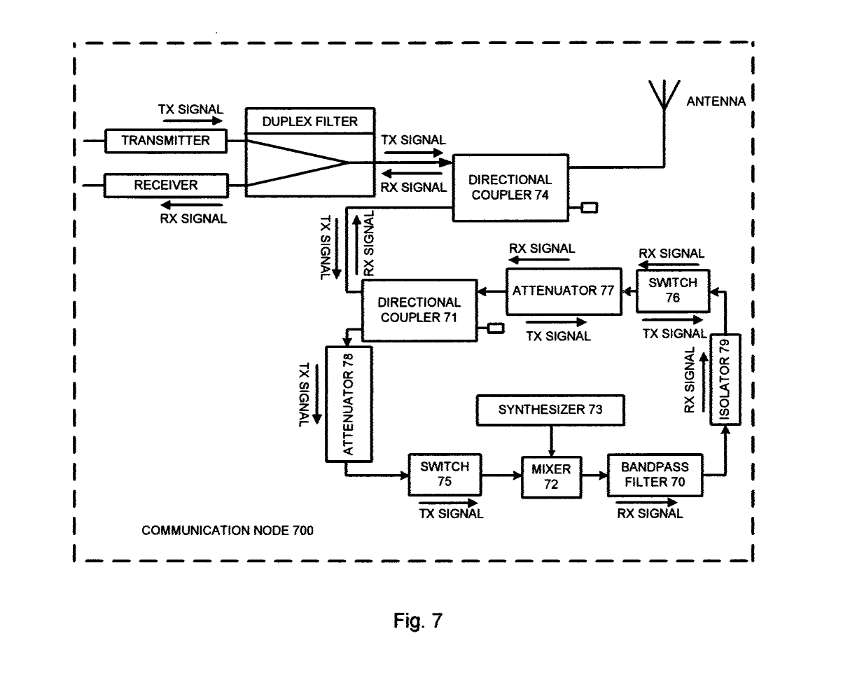

FIG. 7 schematically illustrates a communication node including the RF loop test apparatus in the radio communication system in accordance with an embodiment. Here, the communication node may be representative of, but not limited to, transceiver, base station, NodeB, e-NodeB, and the like.

As illustrated in FIG. 7, the communication node 700 comprises a transmitter, a receiver, a common antenna, and the RF loop test apparatus including a directional coupler 71, a directional coupler 74, a mixer 72 and a synthesizer 73. It should also be appreciated that it does not exclude the presence of other elements not shown for other purposes of utility in the communication node. In the following, the functions of the above elements will be described with reference to the FIG. 7.

The transmitter and receiver are connected to the duplex filter, which couples the input of the receiver and the output of the transmitter to the common antenna. As for the RF loop test apparatus, the directional coupler 74 is operably coupled between the duplex filter and the antenna, where the port 1 of the second directional coupler 74 is coupled to the antenna port of the duplex filter and the port 2 is coupled to the antenna. In normal operation, the input and output signals will be transmitted via the directional coupler 74. The directional coupler 71 in the apparatus is coupled to the port 4 of the directional coupler 74 by the port 1 of the directional coupler 71, and coupled to the mixer 72 with the port 4 in connection with the input of the mixer 72, and the port 2 in connection with the output of the mixer 72. Alternatively, the directional coupler 71 may be coupled to the mixer 72 with the port 2 in connection with the input of the mixer 72, and the port 4 in connection with the output of the mixer 72.

In the loop test, the transmitter sends out a known test signal, which is lead through the duplex filter to the directional coupler 74. The direction coupler 74 receives the test signal at the port 1 and directs the test signal to the directional coupler 71 through the port 4 of the directional coupler 74. The direction coupler 71 receives the test signal at the port 1 (the directional coupler 71 works in mode 1 for the test signal), then couples the test signal and feeds it to the mixer 72 through the port 4, where the frequency of test signal is converted from the transmission frequency to the reception frequency that is receivable by the receiver. Subsequently the frequency-converted test signal is passed back to the directional coupler 71 via the port 2 (the directional coupler 71 works in mode 2 for the frequency-converted test signal), and proceeds via the port 1 of the directional coupler 71 to the directional coupler 74, to the duplex filter and finally reaches the receiver. Thus, the transmitter, the duplex filter and the receiver are covered by the loop test.

Optionally, a switch 75, 76 is coupled between the directional coupler 71 and the mixer 72 on both sides of the mixer 72. The switch is closed only during the RF loop test, in other words, the test loop will be cut off during normal operation of the communication node. Since the RF loop test circuit is placed after the duplex filter and close to the antenna port, it is important to control the level of the spurious signal originating from the active components in the RF loop circuit, such that it will not violate the spurious emission required by the antenna port. Therefore, the switches 75, 76 are open during normal operation to isolate the active components in the RF loop circuit from the antenna port.

Optionally, an attenuator 77, 78 coupled between the directional coupler 71 and the mixer 72 on both sides of the mixer 72, which can be used to control the test signal level for both the test signal from the transmitter and the frequency-converted test signal by the mixer. The test signal level should be low enough to ensure that the signal attenuated in the test loop satisfies the antenna port spurious emission requirements, meanwhile, high enough to ensure that it remains above the sensitivity threshold of the receiver so as to be detected and analyzed by the receiver. Thus the test signal level should be within the range as below:

RX Sensitivity≦Test Signal Level≦Spurious Emission Requirements+Directional Coupler Directivity

Where RX Sensitivity refers to the sensitivity threshold of the receiver, and the Directional Coupler Directivity is the power at the “coupled” port divided by the power at the “isolated” port of the directional coupler 74. In decibels, the directivity is equal to the isolation minus the coupling.

Furthermore, the attenuator 77 coupled on the output side of the mixer 72 may also be used to attenuate the level of the test signal transmitted in the reverse direction, i.e. the direction from the port 2 of the directional coupler 71 to the mixer 72 output, such that the interference resulted from the signal transmission in the reverse direction can be alleviated. Alternatively, an isolator 79 can be set between the first coupler 71 and the mixer 72 on the output side of the mixer 72, which only allows the frequency-converted test signal transmission in one direction from the mixer 72 output to the first directional coupler 71 and blocks the signal transmitted in the direction from the first directional coupler 71 to the mixer 72 output.

Note that the attenuator 77, 78 can be fixed attenuator or variable attenuator. If the attenuator is variable attenuator, the attenuator can be set to the maximum attenuation when the loop test is not in operation, so as to further isolate the active components in the RF loop circuit from the antenna port along with the switch 75, 76.

Optionally, a bandpass filter 70 can be coupled between the directional coupler 71 and the mixer 72 on the output side of the mixer 72, such that unwanted frequency products generated by the mixer 72 can be removed. Ideally, the pass frequency band is the same as the reception frequency band.

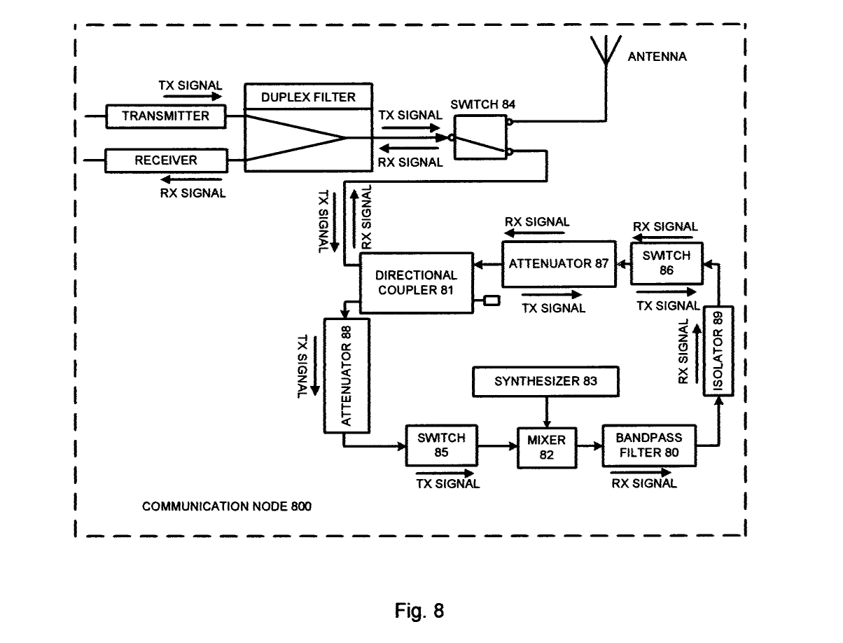

FIG. 8 schematically illustrates a communication node including the RF loop test apparatus in accordance with another embodiment.

As illustrated in FIG. 8, the communication node 800 substantially works in the similar manner as the communication node 700 in FIG. 7, except that the directional coupler 74 is substituted with the switch 84 in the communication node 800. In this way, during the normal operation, the switch 84 will be switched to the antenna so as to establish the connection between the duplex filter and the antenna. When the RF loop test is to be executed, the switch 84 will be switched to the directional coupler 81 to establish the test loop for the transceiver.

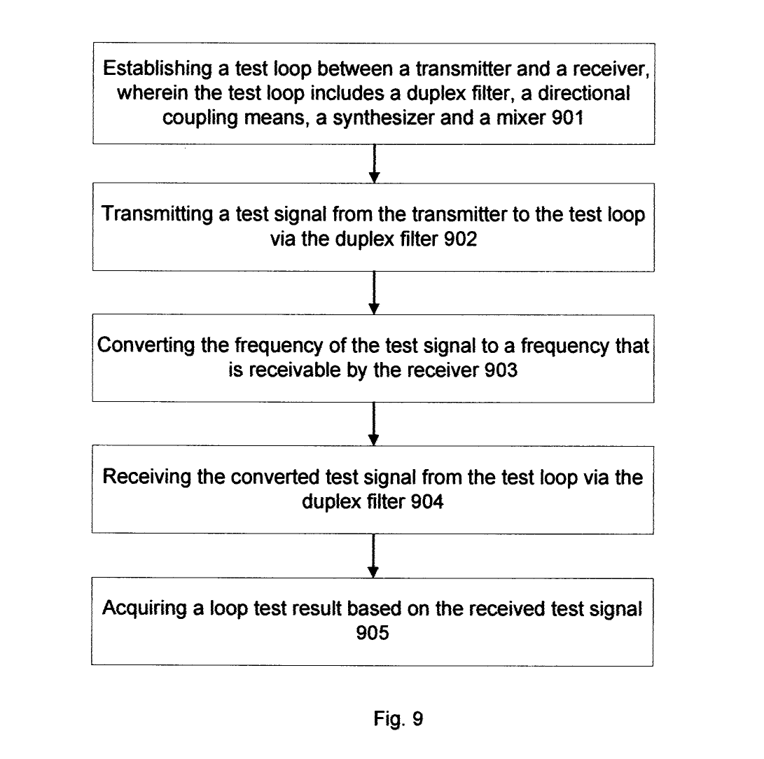

FIG. 9 illustrates a flowchart of a method for testing FDD transceiver in a radio communication system in accordance with an embodiment. The method can be carried out by the RF loop test apparatus as described above. The process of the method will now be described in the following with reference to FIG. 9 and FIG. 7.

In step 901, the process establishes a test loop between a transmitter and a receiver in the communication node 700. The test loop may include a duplex filter, a directional coupler 71, a mixer 72, and the like. As illustrated, the duplex filter and the directional coupler 72 provide two-way transmission path for the test loop. Establishing the test loop may comprise programming the synthesizer to generate a local oscillator signal which will be provided to the mixer. The frequency of local oscillator signal is the frequency difference of the transmitting frequency from the transmitter and the reception frequency receivable by the receiver.

In step 902, a known test signal is sent out from the transmitter and lead through the duplex filter to the test loop.

Then, in step 903, the frequency of the test signal is converted to a reception frequency (receivable by the receiver) by the mixer 72 in the test loop. From there, the frequency-converted test signal proceeds via the duplex filter to the receiver.

Consequently, the frequency-converted test signal is detected and received by the receiver in step 904.

In step 905, the loop test result is acquired based on the frequency-converted test signal received in step 904. Specifically, the received test signal may firstly be checked to determine whether the signal level is within the expected range. If not, a RF loop alarm will arise, otherwise, the received test signal will be compared with the original test signal transmitted from the transmitter to obtain the information such as error vector magnitude (EVM) and bit error rate (BER), which may indicate the state of the transceiver. The way to obtain the EVM and BER is known in the art, which will not be described in more detail for brevity. It should be appreciated that the above manner to acquire the loop test result is described by way of example, and any other suitable manners can be applied to the embodiment.

Optionally, the method may include utilizing a switch (e.g. 75, 76) to cut off the test loop when the loop test is not in operation, such that the active components in the RF loop circuit is isolated from the antenna port. Accordingly, the test loop establishing step 901 may further comprise closing the switch in the test loop.

Optionally, the method may include utilizing the attenuator (e.g. 78) coupled on the input side of the mixer to control the level of the test signal to the mixer and utilizing the attenuator (e.g. 77) coupled on the output side of the mixer to control the level of frequency-converted test signal by the mixer. The attenuator 77 may be further used to attenuate the level of the test signal transmitted in the reverse direction, i.e. the direction from the first directional coupler 71 to the mixer 72 output, such that the interference resulted from the signal transmission in the reverse direction can be alleviated.

Note that the attenuators 77, 78 can be fixed attenuator or variable attenuator. If the attenuator is variable attenuator, the method may include setting the attenuators to the maximum attenuation when the loop test is not in operation, so as to further isolate the active components in the RF loop circuit from the antenna port. Moreover, when the attenuator is variable attenuator, the test loop establishing step 901 may further comprise setting the attenuators to the appropriate attenuation value.

Optionally, the method may include utilizing a bandpass filter (e.g. 70) coupled between the directional coupler 71 and the mixer 72 on the output side of the mixer 72, such that unwanted frequency products generated by the mixer 72 can be removed. Ideally, the pass frequency band is the same as the reception frequency band.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore it is intended that the present embodiments not be limited to the particular embodiment disclosed as the best mode contemplated for carrying out the present technology, but that the present embodiments include all embodiments falling within the scope of the appended claims.

1. A radio frequency, RF, loop test apparatus for testing Frequency Division Duplexing, FDD, transceiver in a radio communication system, the apparatus comprises:
A first directional coupling means operably coupled to receive, at a first port of the first directional coupling means, a test signal from a transmitter via a duplex filter; and
A Mixer operably coupled to receive the test signal from a second port of the first directional coupling means, convert the frequency of the test signal from the transmitter to a frequency that is receivable by a receiver;
Wherein the first directional coupling means operably coupled to receive, at a third port of the first directional coupling means, the converted test signal from the mixer; and output, at the first port of the first directional coupling means, the converted test signal to the receiver via the duplex filter.

2. The apparatus according to the claim 1, wherein the first directional coupling means is a directional coupler or a power divider.

3. A communication node comprising a transmitter, a receiver, a duplex filter and a common antenna in a radio communication system, wherein the duplex filter couples the input of the receiver and the output of the transmitter to the common antenna, wherein the communication node further comprises an RF loop test apparatus according to any one of the preceding claims.

4. The node according to the claim 3, wherein the apparatus further comprises:
A second coupling means operably coupled between the duplex filter and the antenna, with a first port of the second coupling means coupled to the antenna port of the duplex filter and a second port of the second coupling means coupled to the antenna;
Wherein the second coupling means receives, at the first port of the second coupling means, the test signal from the transmitter via the duplex filter;
the first directional coupling means coupled to receive, at the first port of the first directional coupling means, the test signal from a third port of the second coupling means, and output, at the first port of the first directional coupling means, the converted test signal by the mixer to the third port of the second coupling means; and
the second coupling means outputs, at the first port of the second coupling means, the converted test signal to the receiver via the duplex filter.

5. The node according to claim 3, wherein the apparatus further comprises:
A switch coupled between the first directional coupling means and the mixer on either side of the mixer, which is closed only during the RF loop test.

6. The node according to the claim 4, wherein the apparatus further comprises:
An attenuator coupled between the first directional coupling means and the mixer on either side of the mixer, which is adapted to control the test signal level and is set to the maximum attenuation when the loop test is not in operation.

7. The node according to the claim 6, wherein the attenuator is a fixed attenuator or a variable attenuator.

8. The node according to the claim 4, wherein the apparatus further comprises:
A bandpass filter coupled between the first directional coupling means and the mixer on the output side of the mixer.

9. The node according to the claim 4, wherein the apparatus further comprises:
An isolator coupled between the first directional coupling means and the mixer on the output side of the mixer, which allows the converted test signal transmission in one direction from the mixer output to the first directional coupling means and blocks the test signal transmitted in the direction from the first directional coupling means to the mixer output.

10. The node according to the claim 4, wherein the second coupling means is a directional coupler or a switch.

11. The node according to claim 3, wherein the apparatus is integrated within the duplex filter.

12. The method for testing Frequency Division Duplexing, FDD, transceiver in a radio communication system, the method comprises:
Establishing a test loop between a transmitter and a receiver, wherein the test loop includes a duplex filter, a directional coupling means, a synthesizer and a mixer, the duplex filter and the directional coupling means provide two-way transmission path for the test loop;
Transmitting a test signal from the transmitter to the test loop via the duplex filter;
Converting the frequency of the test signal to a frequency that is receivable by the receiver;
Receiving the converted test signal from the test loop via the duplex filter; and
Acquiring a loop test result based on the received test signal.

13. The method according to the claim 12, the method further comprises:
utilizing at least one switch to cut off the test loop when the loop test is not in operation.

14. The method according to the claim 13, the method further comprises:
utilizing a first attenuator coupled on the input side of the mixer to control the test signal level to the mixer.

15. The method according to the claim 14, the method further comprises:
utilizing a second attenuator coupled on the output side of the mixer to attenuate the level of the test signal transmitted in the direction from the first directional coupling means to the mixer output, and to control the converted test signal level.

16. The method according to the claim 15, the method further comprises:
If the first attenuator or the second attenuator is variable attenuator, setting the respective attenuator to the maximum attenuation to isolate the test loop when the loop test is not in operation.

17. The method according to claim 16, wherein the step of establishing the test loop comprises:
Closing the switch in the test loop;
Programming a synthesizer to generate a local oscillator signal provided to the mixer, the frequency of local oscillator signal is the frequency difference of the transmitting frequency from the transmitter and the frequency receivable by the receiver;
When the first attenuator or the second attenuator is variable attenuator, setting the attenuation value for the respective attenuator.

18. The method according to claim 10, the method comprises:
utilizing a bandpass filter to remove unwanted frequency components from the mixer.
